(19) United States
(12) Patent Application Publication
(10) Pub. No.: US 2017/0178159 A1
(43) Pub. Date: Jun. 22, 2017

(54) METHODS FOR EFFECTING AND OPTIMIZING ITEM DESCRIPTOR AND ITEM VALUE COMBINATIONS

(71) Applicant: MasterCard International Incorporated, Purchase, NY (US)

(72) Inventors: Rohit Modi, New Delhi (IN); Shuvam Sengupta, Gurgaon (IN); Ashutosh Kumar Gupta, Varanasi (IN)

(21) Appl. No.: 15/380,667

(22) Filed: Dec. 15, 2016

(30) Foreign Application Priority Data
Dec. 17, 2015 (SG) 10201510392W

(51) Int. Cl. G06Q 30/02

(52) U.S. Cl. CPC G06Q 30/0202

(57) ABSTRACT

A method for optimizing an item descriptor and item value combination is provided. The method includes receiving initial data, locating one or more previous transaction data points, and creating a plurality of candidate opportunity variants and, for each candidate opportunity variant determining a first deviation, identifying a first set of first previous transaction data points and a second set of previous transaction data point, and forecasting one or more new transaction data points at at least one future date, each new transaction data point includes a forecast merchant identifier. The method further includes selecting the candidate opportunity variant that provides an optimized item descriptor and item value combination based on the selected candidate opportunity variant.

### CROSS REFERENCE TO RELATED APPLICATIONS

This application claims the benefit of Singapore Patent Application No. 10201510392W filed Dec. 17, 2015, which is hereby incorporated by reference in its entirety.

### BACKGROUND

The present disclosure relates to a method for effecting and optimizing item descriptor and item value combinations. In particular, the present disclosure relates, but is not limited, to determining the effects of changes in an offering including an item descriptor and item value combination, on consumer behavior in relation to that offering.

Over the lifetime of a product the demand for that product is likely to change, as is the cost of supplying that demand. This is particularly the case for perennial products such as food and beverage products.

Consumers typically do not see the fluctuations in cost of supply, such as raw material and labor costs. Consumer demand is instead predominantly affected by price and what is offered for that price, and demand often fluctuates according to that price and offering.

When seeking to increase revenue, merchants will often seek to increase sales and/or increase the price of a particular product. However, it is difficult for a merchant to determine how consumers will respond to price increase, or decreases for that matter, and product changes—for example, it is difficult for a merchant to understand whether it will derive more profit from selling a larger volume coffee in place of a smaller volume coffee, or whether consumers will be effected by a small increase in price.

It would, therefore, be desirable to provide a mechanism by which merchants can ascertain, with relative confidence, the effect on consumer demand of various changes in a product and the price requested for that product.

### BRIEF DESCRIPTION

The present disclosure provides a method for optimizing an item descriptor and item value combination. The method includes receiving initial data that includes an initial item descriptor, an initial merchant identifier, and an initial item value, and locating, from a database that includes previous transaction data points, one or more previous transaction data points, each includes an archival item descriptor, the archival item descriptor being comparable to the initial item descriptor, an archival merchant identifier, an archival item value, and a transaction date. The method also includes creating a plurality of candidate opportunity variants, each includes a candidate item descriptor that is comparable to the initial item descriptor, and a candidate item value and, for each candidate opportunity variant determining a first deviation, being a deviation of the respective candidate item descriptor and candidate item value from the respective initial item descriptor and initial item value, identifying, in the one or more previous transaction data points, a first set of first previous transaction data points and a second set of previous transaction data points, wherein the transaction dates of the previous transaction data points of the first set are earlier than the transaction dates of the previous transaction data points of the second set, a second deviation, being a deviation between the archival item descriptors and archival item values of the previous transaction data points of the second set and the archival item descriptors and candidate item values of the previous transaction data points of the first set, is associable to the first deviation, and forecasting a number of new transaction data points at at least one future date, each new transaction data point includes a forecast merchant identifier, and where the forecast merchant identifier is the initial merchant identifier, the respective new transaction data point includes the respective candidate item descriptor and candidate item value, and a forecast merchant identifier. The method further includes selecting the candidate opportunity variant that provides an optimized item descriptor and item value combination based on the selected candidate opportunity variant having a higher number of new transaction data points, for which the forecast merchant identifier is the initial merchant identifier, than the other candidate opportunity variants, and/or a higher total value than a total value for the other candidate opportunity variants, wherein the total value for each candidate opportunity variant is the respective number of new transaction data points multiplied by the respective candidate item value.

The present disclosure also provides a method for determining an effect of a deviation in an item descriptor and item value combination. The method includes receiving an initial item description and item value combination, and a proposed item descriptor and item value combination, determining a first deviation, being a deviation of the proposed item descriptor and proposed item value from the respective initial item descriptor and initial item value, and locating, from a database that includes previous transaction data points, one or more previous transaction data points, each includes an archival item descriptor, the archival item descriptor being comparable to the initial item descriptor, an archival merchant identifier, an archival item value, and a transaction date. The method also includes identifying, in the one or more previous transaction data points, a first set of first previous transaction data points and a second set of previous transaction data points, wherein the transaction dates of the previous transaction data points of the first set are earlier than the transaction dates of the previous transaction data points of the second set, and a second deviation, being a deviation between the archival item descriptors and archival item values of the previous transaction data points of the second set and the archival item descriptors and candidate item values of the previous transaction data points of the first set, is associable to the first deviation. The method further includes forecasting a number of new transaction data points at at least one future date, each new transaction data point includes a forecast merchant identifier.

The present disclosure also provides a computer system for optimizing an item descriptor and item value combination. The computer system includes a memory device for storing data, a display, and a processor coupled to the memory device configured to receive initial data that includes an initial item descriptor, an initial merchant identifier, and an initial item value, locate, from a database that includes one or more previous transaction data points, each includes an archival item descriptor, the archival item descriptor being comparable to the initial item descriptor, an archival merchant identifier, an archival item value, and a transaction date. The processor coupled to the memory device also configured to create a plurality of candidate opportunity variants each includes a candidate item descriptor that is comparable to the initial item descriptor, and a candidate item value and, for each candidate opportunity variant determine a first deviation, being a deviation of the respective candidate item descriptor and candidate item value from the respective initial item descriptor and initial item value, identify, in the one or more previous transaction data points, a first set of first previous transaction data points and a second set of previous transaction data points, wherein the transaction dates of the previous transaction data points of the first set are earlier than the transaction dates of the previous transaction data points of the second set, and a second deviation, being a deviation between the archival item descriptors and archival item values of the previous transaction data points of the second set and the archival item descriptors and candidate item values of the previous transaction data points of the first set, is associable to the first deviation, and forecast a number of new transaction data points at at least one future date, each new transaction data point includes a forecast merchant identifier, and where the forecast merchant identifier is the initial merchant identifier, the respective new transaction data point includes the respective candidate item descriptor and candidate item value, and a forecast merchant identifier. The processor coupled to the memory device further configured to select the candidate opportunity variant that provides an optimized item descriptor and item value combination based on the selected candidate opportunity variant having a higher number of new transaction data points, for which the forecast merchant identifier is the initial merchant identifier, than the other candidate opportunity variants, and/or a higher total value than a total value for the other candidate opportunity variants, wherein the total value for each candidate opportunity variant is the respective number of new transaction data points multiplied by the respective candidate item value.

The present disclosure also provides a computer system for determining an effect of a deviation in an item descriptor and item value combination. The computer system includes a memory device for storing data, a display, and a processor coupled to the memory device configured to receive an initial item descriptor and item value combination, and a proposed item descriptor and item value combination, determine a first deviation, being a deviation of the proposed item descriptor and proposed item value from the respective initial item descriptor and initial item value, and locate, from a database that includes previous transaction data points, one or more previous transaction data points each includes an archival item descriptor, the archival item descriptor being comparable to the initial item descriptor, an archival merchant identifier, an archival item value, and a transaction date. The processor coupled to the memory device is also configured to identify, in the one or more previous transaction data points, a first set of first previous transaction data points and a second set of previous transaction data points, wherein the transaction dates of the previous transaction data points of the first set are earlier than the transaction dates of the previous transaction data points of the second set, and a second deviation, being a deviation between the archival item descriptors and archival item values of the previous transaction data points of the second set and the archival item descriptors and candidate item values of the previous transaction data points of the first set, is associable to the first deviation. The processor coupled to the memory device further configured to forecast a number of new transaction data points at at least one future date, each new transaction data point includes a forecast merchant identifier.

The present disclosure also provides a computer program embodied on a non-transitory computer readable for optimizing an item descriptor and item value combination, the program includes at least one code segment executable by a computer to instruct the computer to receive initial data that includes an initial item descriptor, an initial merchant identifier, and an initial item value, locate, from a database that includes previous transaction data points, one or more previous transaction data points each includes an archival item descriptor, the archival item descriptor being comparable to the initial item descriptor, an archival merchant identifier, an archival item value, and a transaction date. The program also includes at least one code segment executable by a computer to instruct the computer to create a plurality of candidate opportunity variants each includes a candidate item descriptor that is comparable to the initial item descriptor, and a candidate item value and, for each candidate opportunity variant determine a first deviation, being a deviation of the respective candidate item descriptor and candidate item value from the respective initial item descriptor and initial item value, identify, in the one or more previous transaction data points, a first set of first previous transaction data points and a second set of previous transaction data points, wherein the transaction dates of the previous transaction data points of the first set are earlier than the transaction dates of the previous transaction data points of the second set, and a second deviation, being a deviation between the archival item descriptors and archival item values of the previous transaction data points of the second set and the archival item descriptors and candidate item values of the previous transaction data points of the first set, is associable to the first deviation, and forecast a number of new transaction data points at at least one future date, each new transaction data point comprising a forecast merchant identifier, and where the forecast merchant identifier is the initial merchant identifier, the respective new transaction data point comprises the respective candidate item descriptor and candidate item value, and a forecast merchant identifier. The program further includes at least one code segment executable by a computer to instruct the computer to select the candidate opportunity variant that provides an optimized item descriptor and item value combination based on the selected candidate opportunity variant having a higher number of new transaction data points, for which the forecast merchant identifier is the initial merchant identifier, than the other candidate opportunity variants, and/or a higher total value than a total value for the other candidate opportunity variants, wherein the total value for each candidate opportunity variant is the respective number of new transaction data points multiplied by the respective candidate item value.

The present disclosure also provides a computer program embodied on a non-transitory computer readable for determining an effect of a deviation in an item descriptor and item value combination, the program includes at least one code segment executable by a computer to instruct the computer to receive an initial item descriptor and item value combination and a proposed item descriptor and item value combination, determine a first deviation, being a deviation of the proposed item descriptor and proposed item value from the respective initial item descriptor and initial item value, and locate, from a database that includes previous transaction data points, one or more previous transaction data points each includes an archival item descriptor, the archival item descriptor being comparable to the initial item descriptor, an archival merchant identifier, an archival item value, and a transaction date. The program also includes at least one code segment executable by a computer to instruct the computer to identify, in the one or more previous transaction data points, a first set of first previous transaction data points and a second set of previous transaction data points, wherein the transaction dates of the previous transaction data points of the first set are earlier than the transaction dates of the previous transaction data points of the second set, and a second deviation, being a deviation between the archival item descriptors and archival item values of the previous transaction data points of the second set and the archival item descriptors and candidate item values of the previous transaction data points of the first set, is associable to the first deviation. The program further includes at least one code segment executable by a computer to instruct the computer to forecast a number of new transaction data points at at least one future date, each new transaction data point comprising a forecast merchant identifier.

The present disclosure also provides a network-based system for optimizing an item descriptor and item value combination. The system includes a client computer system, at least one database, a display, and a server system coupled to the client computer system and the database. The server system configured to receive, from the client computer system, the initial data that includes an initial item descriptor, an initial merchant identifier, and an initial item value, and locate, from a database comprising previous transaction data points, one or more previous transaction data points each includes an archival item descriptor, the archival item descriptor being comparable to the initial item descriptor, an archival merchant identifier, an archival item value, and a transaction date. The server system also configured to create a plurality of candidate opportunity variants each comprising a candidate item descriptor that is comparable to the initial item descriptor, and a candidate item value and, for each candidate opportunity variant determine a first deviation, being a deviation of the respective candidate item descriptor and candidate item value from the respective initial item descriptor and initial item value identify, in the one or more previous transaction data points, a first set of first previous transaction data points and a second set of previous transaction data points, wherein the transaction dates of the previous transaction data points of the first set are earlier than the transaction dates of the previous transaction data points of the second set, and a second deviation, being a deviation between the archival item descriptors and archival item values of the previous transaction data points of the second set and the archival item descriptors and candidate item values of the previous transaction data points of the first set, is associable to the first deviation, and forecast a number of new transaction data points at at least one future date, each new transaction data point comprising a forecast merchant identifier, and where the forecast merchant identifier is the initial merchant identifier, the respective new transaction data point that includes the respective candidate item descriptor and candidate item value, and a forecast merchant identifier. The server system further configured to select the candidate opportunity variant that provides an optimized item descriptor and item value combination based on the selected candidate opportunity variant having a higher number of new transaction data points, for which the forecast merchant identifier is the initial merchant identifier, than the other candidate opportunity variants, and/or a higher total value than a total value for the other candidate opportunity variants, wherein the total value for each candidate opportunity variant is the respective number of new transaction data points multiplied by the respective candidate item value.

The present disclosure also provides a network-based system for determining an effect of a deviation in an item descriptor and item value combination. The system includes a client computer system, at least one database, a display, and a server system coupled to the client computer system and the database. The server system configured to receive, from the client computer system, an initial item descriptor and item value combination and a proposed item descriptor and item value combination, determine a first deviation, being a deviation of the proposed item descriptor and proposed item value from the respective initial item descriptor and initial item value, and locate, from a database comprising previous transaction data points, one or more previous transaction data points each includes an archival item descriptor, the archival item descriptor being comparable to the initial item descriptor, an archival merchant identifier, an archival item value, and a transaction date. The server system also configured to identify, in the one or more previous transaction data points, a first set of first previous transaction data points and a second set of previous transaction data points, wherein the transaction dates of the previous transaction data points of the first set are earlier than the transaction dates of the previous transaction data points of the second set, and a second deviation, being a deviation between the archival item descriptors and archival item values of the previous transaction data points of the second set and the archival item descriptors and candidate item values of the previous transaction data points of the first set, is associable to the first deviation. The server system further configured to forecast a number of new transaction data points at at least one future date, each new transaction data point comprising a forecast merchant identifier.

The present disclosure still further provides a method for determining an effect of a deviation in an item descriptor and item value combination. The method includes receiving an initial item descriptor and item value combination and a proposed item descriptor and item value combination, determining a first deviation, being a deviation of the proposed item descriptor and proposed item value from the respective initial item descriptor and initial item value, and locating, from a database comprising previous transaction data points, one or more previous transaction data points each includes an archival item descriptor, the archival item descriptor being comparable to the initial and/or the proposed item descriptor, an archival merchant identifier, an archival item value, and a transaction date. The method also includes identifying, in the one or more previous transaction data points, a first set of first previous transaction data points and a second set of previous transaction data points, wherein the transaction dates of the previous transaction data points of the first set are earlier than the transaction dates of the previous transaction data points of the second set, and a second deviation, being a deviation between the archival item descriptors and archival item values of the previous transaction data points of the second set and the archival item descriptors and candidate item values of the previous transaction data points of the first set, is associable to the first deviation. The method further includes forecasting a number of new transaction data points at at least one future date, each new transaction data point comprising a forecast merchant identifier.

Unless context dictates otherwise, the following terms will be attributed the meaning given:

“Item descriptor” is a description of an item the subject of a transaction. For example, an item descriptor might be a coffee, a coffee of a particular volume or type, a coffee and an accompanying treat, such as a biscuit, and so forth.

Item descriptors are taken to “match”, be “matching” or “matches”, or to be “comparable” or similar, where consumer behavior towards a change in price of one of the item descriptors can be expected to be similar to consumer behavior towards a similar change in price in the other item descriptor. The same applies to changes in the item descriptor itself. For example, consumer behavior to changes in the price of a 450 mL coffee will likely be similar to consumer behavior to changes in the price of a 380 mL coffee. Likewise, consumer behavior to changes in the item descriptor, such as a change in the volume of the coffee or the addition/removal of an accompanying treat (e.g. a biscuit) will likely be similar.

A “merchant identifier” refers to a particular merchant such that a particular transaction data point having that merchant identifier relates to a transaction having taken place with that particular merchant. Where the merchant represents a group of outlets or merchants, a chain of outlets, a franchise, one or more outlets in different countries or regions, a single merchant identifier may be used to refer to all relevant outlets, or a different merchant identifier may be used for each outlet, country or region.

“Transaction date” refers to a specific date and/or time, or a period during which a particular transaction took place. For example, a transaction date may be a specific date, such as 12 Oct. 2015, or even 12:30 pm on 12 Oct. 2015, or may alternatively refer to a sales period, such as fourth quarter 2015 of which any sales between 1 Oct. 2015 and 31 Dec. 2015 would form a part.

“Transaction data points” are sales of items described by a particular item descriptor. For example, the sale of a take-away, regular sized coffee at $5 will result in a transaction data point being created with “regular sized coffee” (or 380 mL coffee) as the item descriptor, and $5 as the item value. “Previous transaction data points” will, therefore, be understood to refer to transaction data points having been previously created which can be used as a basis for inferring consumer behavior to changes in item descriptors and/or item values for which future transaction data points are expected.

Deviations are taken to be “associable” where consumer behavior in response to one deviation will likely be similar to consumer behavior to another deviation. For example, where previous transaction data points show that consumers previously had no significant response to a 5% price change in an item descriptor (i.e. in the price for purchasing an item described by that descriptor) offered by one merchant, then it can be assumed that a price change of 5% made by another merchant will similarly have little effect on demand.

A “transactor identifier” identifies a particular party making a transaction resulting in creation of a transaction data point, or that a person from a particular customer segment (e.g. males, individuals aged 25 to 34, corporate entities, and so forth) has made a transaction resulting in creation of a transaction data point.

The term “archival” refers to the state of a piece of information having been archived or otherwise recorded for use in future analyzes.

The term “candidate opportunity variant” refers to a test case set of parameters (e.g. item descriptor and item value combination) that, if proven to be a useable set of parameters, can be directly translated into an offering. For example, a candidate opportunity variant may be a regular sized coffee offered for $4.50. If that candidate opportunity variant proves to optimize profit according to the methods set out below, then that candidate opportunity variant can be directly translated into an offering to consumers.

### BRIEF DESCRIPTION OF THE DRAWINGS

Some embodiments will now be described by way of non-limiting example only, with reference to the accompanying drawings in which:

FIG. 1 depicts steps in a method for optimizing an item descriptor and item value combination;

FIG. 2 depicts steps in a method for optimizing an item descriptor and item value combination;

FIG. 3 illustrates a process flowchart for implementing methods according to FIGS. 1 and 2;

FIG. 4 provides example data upon which the present methods (e.g. those provided in FIGS. 1 and 2) can be applied;

FIG. 5 is an expanded block diagram of an exemplary embodiment of a server architecture of a computer system for determining a fruition score;

FIG. 6 illustrates an exemplary configuration of a server system shown in FIG. 5; and

FIG. 7 depicts scenarios in which changes are made to initial data and the consumer response thereto.

### DETAILED DESCRIPTION

Embodiments of the present disclosure will be described, by way of example only, with reference to the drawings. Where convenient, like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic, or optical signals capable of being stored, transferred, combined, compared, and otherwise manipulated.

Unless specifically stated otherwise, and as apparent from the following, it will be appreciated that throughout the present specification, discussions utilizing terms, such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may include a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a general-purpose computer effectively results in an apparatus that implements the steps of the preferred method.

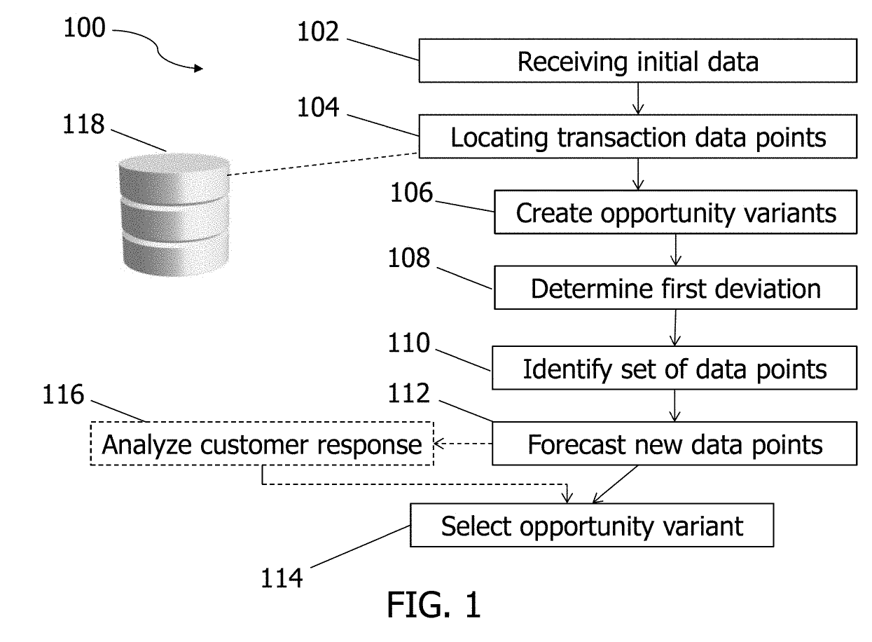

Described herein are various methods employing archived transaction data to infer consumer behavior in relation to planned changes in product offerings. Such changes may involve a change in price, a change in the product or the provision of an additional product to accompany the product sought to be purchased by a consumer (e.g. a biscuit to accompany a coffee). Some methods relate to optimizing an item descriptor and item value combination. One such method is shown in FIG. 1, generally designated by reference numeral 100, and broadly includes:

Step 102: receiving initial data;
Step 104: locating previous transaction data points;
Step 106: creating candidate opportunity variants;
Step 108: determining a first deviation;
Step 110: identifying sets of relevant previous transaction data points;
Step 112: forecasting new transaction data points; and
Step 114: selecting a particular candidate opportunity variant.

In step 102 initial data is received by a processor. The initial data includes an initial item descriptor, an initial merchant identifier and an initial item value—for example, a coffee, Starbucks™, and $6.50 respectively. The initial data establishes the main product (i.e. that specified by the item descriptor), or combination of price and product, on which analysis is to be performed. This initial data may be specified by a merchant seeking to determine whether a change in price or product (i.e. item descriptor) would result in greater or fewer sales, higher or lower profit or larger or smaller market share.

Where no initial item value is specified, an estimate may be made based on previous transaction data elements or other sales data of the merchant defined by the initial merchant identifier. Alternatively, an initial item value may be specified by determining, from previous transaction data elements, the average item value of an item conforming to the item descriptor, being sold to a particular customer segment to which the merchant wishes to market their products. To that end, the initial data may further include an initial transactor identifier from which the particular customer segment can be ascertained.

Step 104 involves locating, in a database 118 that includes previous transaction data points, one or more previous transaction data points. The particular previous transaction data points sought to be located are those from which consumer behavior to future changes in the initial data can be inferred.

Each previous transaction data point includes:

an archival item descriptor;
an archival merchant identifier;
an archival item value; and
a transaction date.

The term “archival” simply represents that the data relates to a transaction that has already taken place and details of that transaction have been stored as a previous transaction data point, rather than a new or future transaction data point, in memory.

The archival item descriptor of the transaction data points in question is comparable to the initial or “target” item descriptor. This is because the memory—for example a database—in which the archival transaction data points are stored may contain transaction data points for a large variety of transactions, from various industries, customer segments, and for a wide variety of products. Thus, the transaction data points in question are those that relate to the particular product or products described by the initial item descriptor or those that are at least comparable to that initial item descriptor.

Where the initial merchant identifier identifies a merchant in a particular region, country, city, or other geographical regional limitation, the previous transaction data points may be limited to those in the relevant geographical region.

Some businesses and products have seasonal attraction with consumers. For example, in some countries water parks are poorly attended in Winter but have very high attendance in Summer. The initial data may, therefore, include an initial transaction season or date range and step 104 involves locating previous transaction data points from that season or date range.

In principle, any data captured during a transaction can be represented in the previous transaction data points, and thus can form part of the initial data. Similarly, such data can form a property of the previous transaction data by which the previous transaction data can be limited, or analyzed against candidate variants per step 110.

Thus, step 104 locates previous transaction data points having sufficient similarity with the initial data that changes in that initial data can be inferred from comparable changes between two date ranges in the previous transaction data.

Step 106 involves creating a plurality of candidate opportunity variants. The candidate opportunity variants are, in effect, test scenarios for changes to the initial data. Each candidate opportunity variant differs from the initial data by some amount such that the candidate opportunity variant represents a change or deviation from the initial data, and the previous transaction data points can then be used to determine what effect that change or deviation would have on consumer behavior.

Each of the candidate opportunity variants includes a candidate item descriptor that is comparable to the initial item descriptor, and a candidate item value. Additional parameters may be used where, for example, the initial data includes such parameters.

Step 108 involves determining a first deviation embodied by the candidate opportunity variant. Since the initial data includes an item descriptor and item value, the first deviation is a deviation of the respective candidate item descriptor and candidate item value from the respective initial item descriptor and initial item value. It will be appreciated that the candidate opportunity variant represents such a deviation even where only one of the two parameters (i.e. item descriptor and item value) has been varied since a deviation in one of those two parameters will result in the initial item descriptor and initial item value deviating from the candidate item descriptor and candidate item value.

The candidate opportunity variants may be randomly determined, or may be established based on pre-determined variations. For example, the candidate item value may be set so as to represent a deviation of +5%, +10% or +25%, or +$0.2, +$0.5 or +$1 to the initial item value. Similarly, taking the example where the initial item descriptor comprises a 400 mL coffee, the candidate item descriptor may be set to be 350 mL, 380 mL, 450 mL or 500 and/or the addition (or removal) of a cookie, biscuit, baked good, and so forth.

Under step 110, sets of previous transaction data points are identified in the previous transaction data points located under step 104. In particular, a first set of first previous transaction data points and a second set of previous transaction data points are identified, in which:

the transaction dates of the previous transaction data points of the first set are earlier than the transaction dates of the previous transaction data points of the second set; and

a second deviation, being a deviation between the archival item descriptors and archival item values of the previous transaction data points of the second set and the archival item descriptors and candidate item values of the previous transaction data points of the first set, is associable to the first deviation.

Thus, the first set of previous transaction data points is taken from a period in time that chronologically precedes the second set of previous transaction data points. Thus, the effect on consumer behavior of a change in price or other parameter can be seen in the transaction data points.

Each transaction data point in the first set of previous transaction data points may include the same merchant identifier as a transaction data point in the second set of previous transaction data points. This addition would result in the effect on consumer behavior experienced by a particular merchant, group or chain of merchants of a change in the product offering.

The previous transaction data points in the first data set and the second data set may each have the same merchant identifier. Thus, there may be further data sets—for example, third and fourth data sets—including previous transaction data points for a different merchant identifier. Using this embodiment, the third data set, for example, may be taken from the same period in time or a later period in time, than the second data set.

The data sets may also be weighted so as to preference those data sets that are more likely to represent current consumer sentiment and behavior towards changes in product offering. For example, where third, fourth, and greater data sets are identified for analysis, data sets occurring at a later point in time and/or during particular seasons or date ranges, may be given a higher weighting than older data sets.

Step 112 involves forecasting a number of new transaction data points. The new transaction data points enable a determination to be made of the number of consumers that will remain with, or be attracted to, the merchant identified by the initial merchant identifier if the relevant first deviation specified by the candidate opportunity variant were made to the product offering represented in the initial data.

Each new transaction data point includes a forecast merchant identifier. While the forecast may only determine whether the merchant represented by the initial merchant identifier has increased or decreased sales, and thus rely on new transaction data points for which the forecast merchant identifier is the initial merchant identifier, the forecast may similarly forecast the sales changes experienced by competitors (i.e. new transaction data points for which the forecast merchant identifier differs from the initial merchant identifier). This enables various comparative analyzes to be performed to forecast changes in relative positions of particular merchants (e.g. relative market share). In addition, potential changes to buying powered can be inferred—for example, where a merchant makes a greater number of sales of a particular product, their raw material buying power may increase with a consequent decrease in costs. Thus, the merchant may be able to afford to lower prices while maintaining profitability, and thus capture an even greater market share, thereby further increasing buying power and so on. This comparative change in positions is represented by a change in the number of new transaction data points for which the merchant identifier is the initial merchant identifier relative to the number of new transaction data points for which the merchant identifier is a particular merchant identifier other than the initial merchant identifier—in other words, a competitor. Selecting the candidate opportunity variant providing greatest relative market share will then involve identifying the candidate opportunity variant with a higher number of new transaction data points, for which the forecast merchant identifier is the initial merchant identifier, than the other candidate opportunity variants, relative to a number of new transaction data points for which the merchant identifier is the merchant identifier of the competitor. In either case, where the forecast merchant identifier for a particular new transaction data point is the initial merchant identifier, the respective new transaction data point will also include the respective candidate item descriptor and candidate item value, and a forecast merchant identifier.

Thus, the merchant represented by the initial merchant identifier can understand the likelihood that customers will be attracted to their business or to the business of a competitor, and the extent to which new customers are likely to commence purchases, or existing customers are likely to cease purchasing, as a result of the change in the initial data. Rather than simply determining the likely bulk changes in sales of a particular product (i.e. changes exhibited across the full client-base), the present methods have the effect of tracking individual customer migration, and changes in location and number of purchases made by a customer segment.

To determine the number of new transaction data points, it may be assumed that current consumer sentiment will follow previous consumer sentiment represented by the response to the second deviation as shown in the previous transaction data points. Alternatively, external information may be used to influence the forecast. For example, where general consumer sentiment is low or consumer loyalty in a particular area or during a particular economic cycle is higher or lower than normal, then the forecast number of new transaction data points may be proportionally higher or lower.

The number of new transaction data points is forecast for at least one future date. Whereas forecasting the immediate, short-term effect on sales—in other words, the number of new transaction data points—can be ascertained from the previous transaction data points, it can be useful to understand what the medium-term or even long-term effect will be. Medium-term and long-term effects are important indicators of what overall impact there will be if the merchant specified by the initial merchant identifier makes the change proposed by any one of the candidate opportunity variants. For example, where the forecast number of new transaction data points at a medium-term date (e.g. 6 to 8 months from the change in the initial data being made), then an increase in new transaction data points may evidence increased raw material buying power (e.g. buying milk and coffee beans for making coffee) and consequent lower cost. Thus, lowering item value (i.e. price), and thus potentially earning a lower profit in the short-term, may result in higher medium-term or long-term profitability. Similarly, an increase in price may result in higher short-term profitability but a medium-term or long-term reduction in sales, leading to lower buying power and lower profitability.

In addition, it can be difficult for businesses to gauge the effect on their reputation and consumer loyalty to changes in product offering. Thus, by forecasting a number of new transaction data points at a medium-term or long-term date, the merchant is able to determine whether consumers are likely to be attracted to them, pushed towards competitors, enter the market, or exit the market (partially or fully—for example, buying 2 coffees a week instead 4, or entirely ceasing to purchase coffees). If a medium-term or long-term view is desired, the relevant candidate opportunity variant will be analyzed with respect to data sets (e.g. the first set of previous transaction data points and the second set of previous transaction data points) that are chronologically separated by an amount of time similar to the medium-term or long-term timeline. For example, where the medium-term horizon is 6 to 8 months from the date on which a change in the initial data is to be implemented, then the first data set may pre-date the second data set by around 5 to 9 months, 7 months, or some other period that is comparable to the horizon sought to be adduced from the previous transaction data. For a data set, the time assumed for the data set may be any appropriate date—for example, where the first and second data sets are separated by 6 months, the date of the each data set may be the median date of the previous transaction data points of which the respective set is included, or may be the average date of the transaction data points in that set and so on.

Step 114 involves selecting the candidate opportunity variant that provides an optimized item descriptor and item value combination. There is a variety of bases on which such selection can be made. These include the candidate opportunity variant providing the highest sales at a particular date or point in time, highest profit, highest market share, and so on. With respect to the forecast new transaction data points, the highest sales amounts to the candidate opportunity variant having the higher number of new transaction data points, for which the forecast merchant identifier is the initial merchant identifier, than the other candidate opportunity variants. Notably, if the merchant is attracting customers to the market—for example, by lowering prices—some of those customers may choose to purchase from other merchants. In other words, the price change may have made the customer more aware of the industry, but another merchant may have similarly low prices or, for example, a coffee flavor preferred by the new customer. Thus, while higher sales of a fixed market would mean greater market share, this may not be the case where higher sales are experienced in a growing market. Similarly, higher sales do not necessarily equate to higher profitability if the profit per product sold (i.e. product in accordance with the item descriptor) is lower than the profit realized according to the initial data. This may, however, be desirable in order to increase market share to increase buying power, and thereby reduce costs and increase profit, and similarly to, comparatively reduce the buying power of a competitor from whom market share has been captured.

Where higher profitability is desired, the new transaction data points must provide a higher total value than a total value for the other candidate opportunity variants. The total value in this regard is, for each candidate opportunity variant, the number of new transaction data points multiplied by the respective candidate item value.

While item value above has been expressed as the price of an item, it may alternatively be the profit per item. Thus, the item value may represent the difference between the product price and the cost of delivery.

The above method is broadly applicable to analyzing market responses to variations in item descriptor. While such a method can be generally applied to the market, it may be that a particular merchant is targeting one or more specific types of customer or customer segment, and thus data applying to the market in the relevant industry vertical generally will not be particularly accurate for the merchant in question. For example, where a merchant is located in a boutique area where small shops are present and chain and franchise businesses are often unsuccessful, the customer segment may be a particular age group with particular weekly purchases of the product in question and, indeed, other products.

Step 116 involves analysis of the behavior or response of particular customers and customer segments to changes in the initial data. To facilitate such analysis, each previous transaction data point may include an archival transactor identifier. The transactor identifier may identify a particular customer, customer segment, or other property of the customer that made the transaction resulting in the relevant previous transaction data point. Notably, the transaction data points are taken from financial data. That financial data may also identify other purchases made by the customer that indicate the type of customer or segment to which they belong. That data may also indicate other purchases that the customer makes that might be combined with the initial item descriptor. For example, where a customer purchases a coffee from one merchant, and then purchases a cupcake or biscuit from another merchant, a merchant offering a combined coffee and cupcake may be able to capture both sales.

In this case, each new transaction data point will similarly include a transactor identifier. That transactor identifier may be an archival transactor identifier—in other words, a transactor identifier represented in the previous transaction data—or a new transactor identifier representing a new customer. Similarly, the forecasting step can include forecasting a change in the number of new transaction data points for each archival transactor identifier, for which the forecast merchant identifier includes the initial merchant identifier. Such new transaction data points, therefore, represent the change in sales for a particular customer, customer-type, customer segment, and so forth, being made with the merchant in question.

By using a transactor identifier, the previous transaction data points may be limited to those that represent transactors of similar nature to those sought to be targeted by the merchant. Thus, the forecast is more accurately reflective of the target client-base of the merchant than would be an analysis based on transaction data points created by the complete cross-section of all consumers of the product in question.

The method described with reference to FIG. 1 relates broadly to the use of test cases (candidate opportunity variants) in determining how to optimize a product offering (item descriptor and item value). Many similar steps may be used in other methods that seek to determine the effect of a particular, planned change on consumer behavior. One such method for determining an effect of a deviation in an item descriptor and item value combination broadly includes the steps of:

Step 202: receiving item descriptors and item values;

Step 204: determining a deviation from the initial item descriptor and item value;

Step 206: locating previous transaction data points;

Step 208: identifying sets of previous transaction data points; and

Step 210: forecasting new transaction data points.

Step 202 involves receiving an initial item descriptor and item value combination, and a proposed item descriptor and item value combination. The initial item descriptor and item value are representative of the current product offering, whereas the proposed item descriptor and item value are representative of the product offering the merchant is seeking to make, and the effect of which—on consumer behavior—is that which the merchant is seeking to understand. But for the receipt of two combinations of item descriptor and item value, the process and requirements for step 202 are the same as those for step 102.

Step 204 involves determining a first deviation, being a deviation of the proposed item descriptor and proposed item value from the respective initial item descriptor and initial item value. This step is the same as step 108, with the exception that it is not repeated for a plurality of candidate opportunity variants, but is instead calculated for a single, planned or desired change in item descriptor and/or item value. Notably, although step 108 relates to calculating a deviation and step 104 relates to locating previous transaction data points, those steps are reversed in order in the method of 200, namely deviation calculation step 204 is shown to occur before the step 206 of locating previous transaction data points. This illustrates that various steps in either method can be performed out of the sequence shown in the figures. While the claims set out the steps, they are similarly not to be taken as being limited to the order of their introduction except where necessary for the logical order for performance of the claimed method. For example, previous transaction data points must be located before analysis can be performed thereon.

Steps 206, 208, and 210 are the same as steps 104, 110, and 112, with the exception that they are not repetitively performed for each first deviation but are instead performed once for the first deviation calculated from the combination of the initial item descriptor and initial item value, and the combination of the proposed item descriptor and proposed item value. Moreover, since step 210—forecasting new transaction data points—is performed once there is no need to perform a selecting step similar to step 114, there is only a single outcome to select and the merchant must determine whether or not to execute the proposed change.

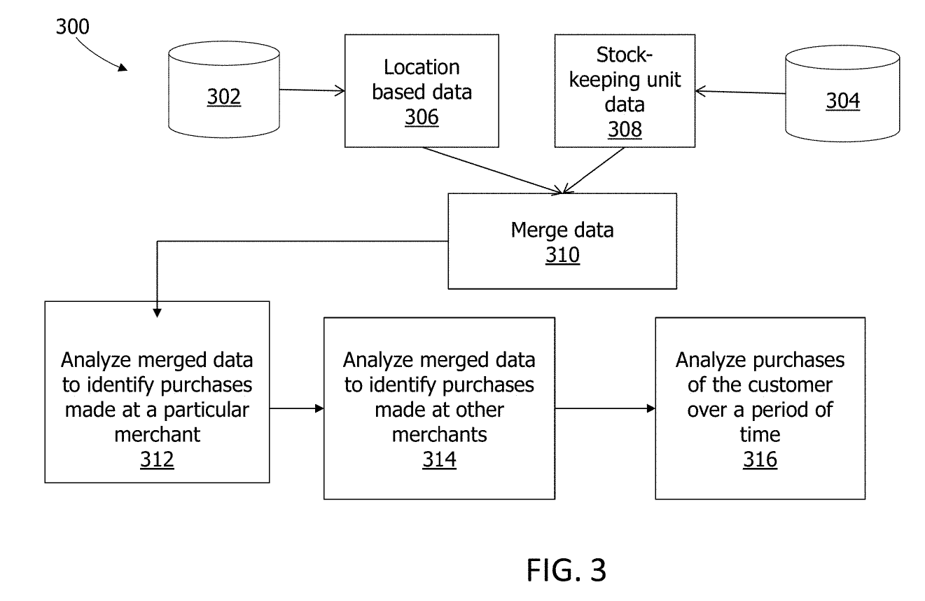

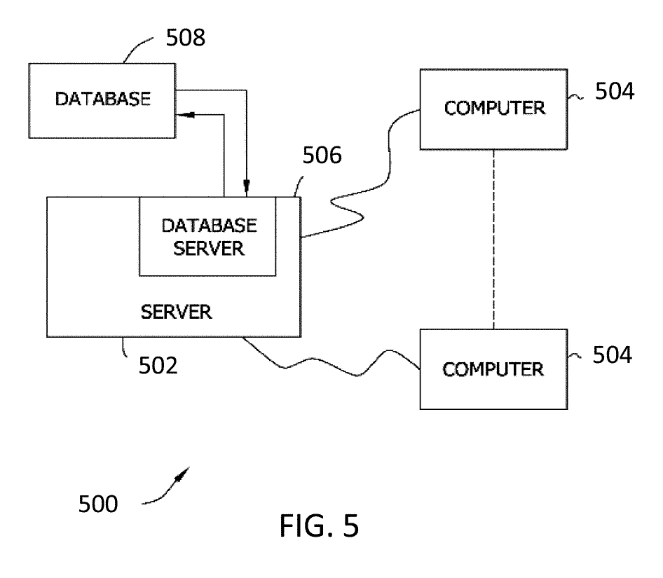

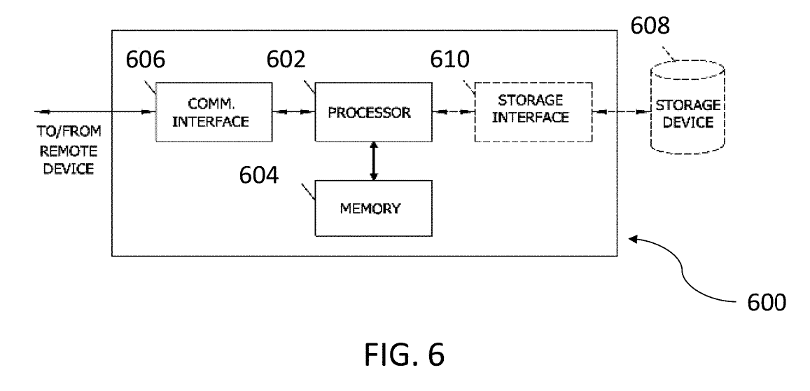

FIG. 3 depicts the flow of data 300 from various sources for analysis in a computing system, such as that shown in FIGS. 5 and 6. The data flow 300 extracts data—for example, previous transaction data points—from two transaction data databases, 302 and 304, augments that data with additional location based data 306 and stock-keeping unit data 308, and merges the data into a single data set 310. The data set is consulted for purchases made by customers at the merchant in question (e.g. the merchant identified by the initial merchant identifier) 312, before purchases by those same customers are analyzed across at least one further merchant. This analysis is performed for at least two dates that are spaced apart by a period sufficient for the effects of consumer behavior to be observed so that changes in that behavior are visible.

Particularly for non-cash transactions, transaction data will be able to be linked back to an individual purchaser through, for example, a credit or debit card number. Thus, the part administering the transaction data database 302 may be a card issuer, payment scheme, or other credit or debit facility provider.

The information retained in the transaction data database 302 may, thus, be any information about the transactions in question, along with information about the individual as provided, for example, during registration of the credit or debit card held by the individual. Thus, customer type and customer segment information can be linked to transactions in the transaction data database 302.

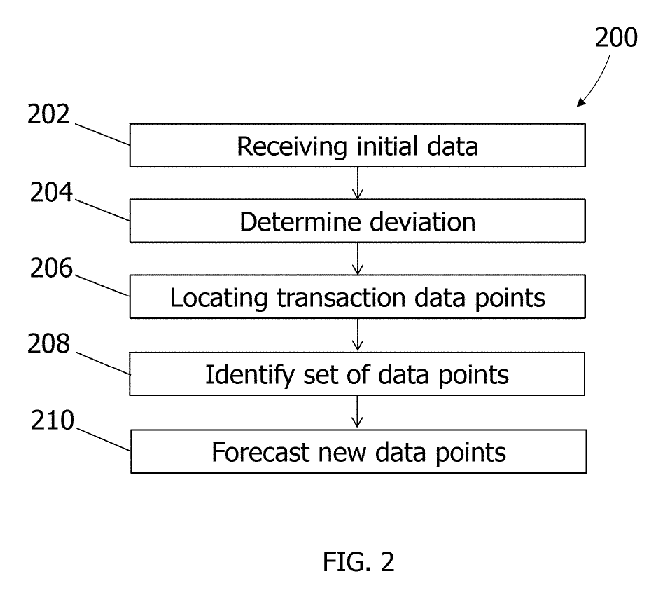

The data extracted from database 302 is augmented with geographical data from database 306. Again, database 306 may be administered by a payment scheme that passes to database 302 only a subset of data created during a transaction. The data in database 306 may include latitude and longitude data identifying the specific location of a merchant, country, region, city or suburb data, or any other data defining a geographical region that may be useful to discern from other geographical regions for the purpose of the analyzes performed in accordance with the methods of FIGS. 1 and 2.

The data in database 304 may also include transaction data. However, this is transaction data recorded by the merchant. It may, therefore, be dissociated from particular card numbers and cardholders. Instead, the transaction data may be linked to customer-related data including raw materials required for producing a product sold to a customer, the time of day each sale is made, the time taken for a product to be served and so forth—notably, merchants will often gather together purchases for reconciling with issuers in bulk, and thus the time of day of a particular transaction may not be evident from the data in database 302.

The data from database 304 is augmented with data from stock-keeping units 308 that track loyalty scheme participation, usage of raw materials (e.g. electricity, milk, and coffee beans for making coffee), total spend, total basket (i.e. where multiple products are purchased), quantity of each product purchased, and so forth. Databases 304 and 308 may, in addition to the data mentioned above, store one or more of the following a ‘transaction key’; an ‘individual key’ 408; a ‘store ID’ 410; a ‘transaction date’ 412; one or more ‘product codes’ 414; a ‘product spend’ 416; a ‘total basket spend’ 418; a ‘total basket quantity’ 420; and one or more ‘total product quantities’ 422—the quantity of a particular product in the basket.

The augmented data from databases or systems 306 and 308 are then merged in system 310, so that transaction level data captured by financial organizations and institutions—namely that stored in database 302 and system 306—can be merged with data captured by the merchant—namely that stored in database 304 and system 308. Thus, a data set can be produced that provides the knowledge of the issuer or payment scheme about the individual making each transaction, and their spending habits, with the merchant-specific information gathered by a merchant.

The merged data is then analyzed at systems 312 and 314 to identify purchases made by particular customers at the merchant in question, and at other merchants, at two points or periods in time. The transactions considered will be such that the first of these two points or periods is selected to be before a particular change in product or price was made—in other words, will constitute the first data set described with reference to FIGS. 1 and 2—and the second of these two points or periods will be after that change—in other words, will constitute the second data set described with reference to FIGS. 1 and 2. The second point or period should be later than the time at which the change was implemented by an amount of time sufficient to enable the effects of the change to be visible in the transaction data. Notably, for short-term profitability analysis, the second point or period may be shortly after the change. For analyzes as to medium-term changes in buying power the second period may be some months after the change. To determine whether the merchant has experienced any detriment or improvement in their reputation, a long-term view might be taken with the second period being 8 to 10 months after the change, or even later.

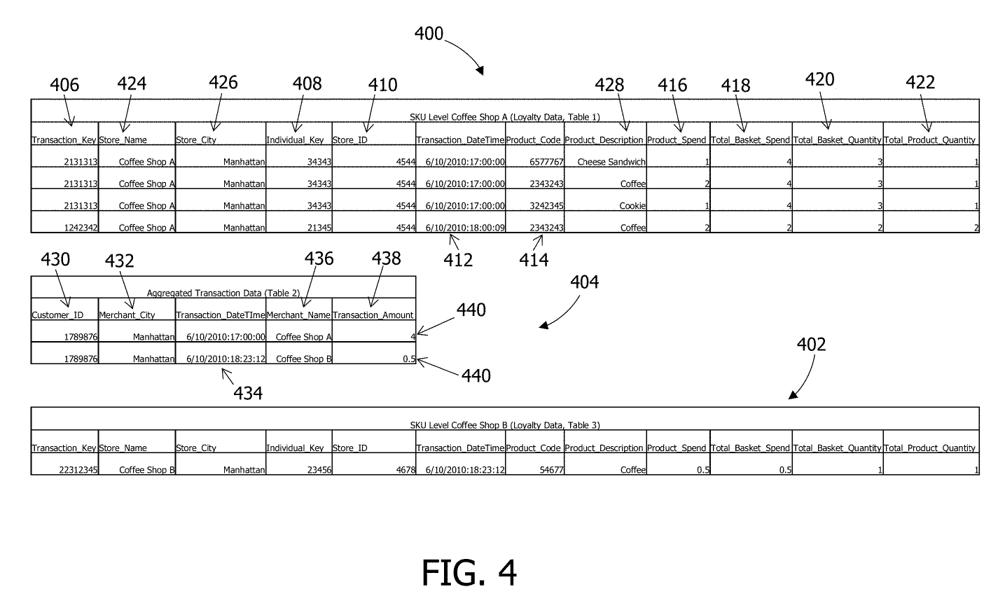

FIG. 4 shows an example of stock-keeping unit data as retained by stock-keeping units and merged with financial data extracted from database 302 and system 306. FIG. 4 includes a tabulated representation of stock-keeping unit (SKU) level data 400 and 402 for Coffee Shop A and Coffee Shop B respectively, and financial transaction data 404 that would be retained, for example, in database 302.

Each of the SKU data tables 400 and 402 includes:

a ‘transaction key’ 406—a unique key that identifies a particular transaction, and thus a unique basket (i.e. group of products purchased by the transaction in question);

an ‘individual key’ 408—a unique key identifying the customer making the transaction the subject of the transaction key;

a ‘store ID’ 410—a unique key identifying the store at which the transaction is taking place;

a ‘transaction date’ 412—the date on which the transaction took place;

one or more ‘product codes’ 414—a unique code, one for each product;

a ‘product spend’ 416—an amount paid for a particular product in the basket;

a ‘total basket spend’ 418—is the total amount spent on all items in the basket;

a ‘total basket quantity’ 420—is the total number of items in the basket; and

one or more ‘total product quantities’ 422—the quantity of a particular product in the basket.

The SKU data tables 400 and 402 also include:

a ‘store name’ 424—an identifier for a particular store or chain of stores;

a ‘store city’ 426—the name, or a token representing the name, of the city or area in which the store is located—this can be useful where the analysis described with reference to FIGS. 1 and 2 are to be employed within a particular area or, where a ‘store name’ 424 represents more than one store, the ‘store city’ 426 can be used to refer to a particular subset of the stores otherwise described by the ‘store name’ 424; and

a ‘product description’ 428—these describe each product uniquely identified by a respective product code 414—in effect, each product code 414 and product description 428 are interchangeable.

The SKU data may be captured routinely or for another reason, such as the implementation of a loyalty program. Since loyalty programs are often administered by third party providers, they can accumulate information about the purchasing habits of individuals across multiple stores linked by the same loyalty program, without necessarily having regard to the payment vehicle used to make the purchases. For example, a loyalty program member who buys a coffee at a first shop using their credit card, and collecting loyalty points for that purchase, may later make another coffee purchase at a second shop using cash, and also collect loyalty points for that second purchase. A credit card issuer would only have access to the purchase made at the first coffee shop, whereas the loyalty program provider would have a record of both transactions.

The financial transaction data 404 includes:

a ‘customer ID’ 430—a unique code identifying a particular customer;

a ‘Merchant city’ 432—in effect, the same of the ‘store city’ 426;

a ‘transaction date’ 434—the same as the transaction date 412 of SKU data tables 400 and 402;

a ‘Merchant name’ 436—the same as the ‘store name’ 424; and

a ‘transaction amount’ 438—the same as the ‘total basket spend’ 418.

Notably, the customer ID 430 is unique to the customer and has no relationship with the stores at which that customer makes their purchases. As such, the same customer ID 430 will be linked to transactions across multiple stores. For example, if a customer uses a particular credit card to make purchases at both Coffee Shop A and Coffee Shop B, the same customer ID 430 will be allocated to all transactions.

Transaction data table 404 can, therefore, show purchases made by a single customer identified by identifier “1789876”. Those purchases include a first transaction 440 made at Coffee Shop A and a second transaction 442 made at Coffee Shop B. Those transactions can then be linked to the product specifics from the SKU data tables 400 and 402 by cross-referencing one or more data elements, such as transaction date 412 and 434, transaction amount 418 and 438, and so on.

By merging transaction level data with SKU level data, the particulars of each in-store purchase can be ascertained for each transaction recorded in the transaction data, and can be correlated across multiple stores. Thus, the analysis performed in accordance with FIGS. 1 and 2 need not be limited to only those purchases visible to the merchant in question, but may instead be broadened to all purchases made by customers for the particular product, or all customers of the merchant in question and whether those customers are likely to move away from, or bring additional purchases to, the merchant after any change is made in the product offering.

FIG. 5 is a simplified block diagram of an exemplary network-based system 500 that may be used for optimizing an item descriptor and item value combination and similarly for determining an effect of a deviation in an item descriptor and item value combination. System 500 is a client/server system that may be utilized for storage and delivery of data. More specifically, in the example embodiment, system 500 includes a server system 502, and at least one client computer system 504. The server system 502 may include the system of a financial institution or a provider of analysis services required for implementation of the methods of FIGS. 1 and 2. The client computer system or system 504 may be the systems of individual merchants, loyalty program providers and other sources of information on transactions occurring at merchant outlets. Presently, the system 500 includes a plurality of client sub-systems, also referred to as client computer systems 504, connected to server system 502. In one embodiment, client systems 504 are computers including a web browser, such that server system 502 is accessible to client systems 504 using the Internet. Client systems 504 may be interconnected to the Internet through a variety of interfaces including a network, such as a local area network (LAN) or a wide area network (WAN), dial-in-connections, cable modems and special high-speed ISDN lines. Client systems 504 could be any device capable of interconnecting to the Internet including a personal computer (PC), a web-based phone, personal digital assistant (PDA), or other web-based connectable equipment.

A database server 506 is connected to database 508, which contains data from which the first data set and second data set can be formed. In one embodiment, centralized database 508 is stored on server system 502 and can be accessed by potential users (e.g. merchants) at one of client systems 504 by logging onto server system 502 through one of client systems 504. In an alternative embodiment, database 508 is stored remotely from server system 502 and may be non-centralized. Database 508 may store electronic files. Electronic files may include transaction data, electronic documents, web pages, maps of geographical regions with purchase density shown for particular products, other image files and/or electronic data of any format suitable for storage in database 508 and delivery using system 500.

More specifically, database 508 may store transaction level data and SKU data collected over a network of client systems 504.

The system 500 may actually be involved in collection of that data. For example, the system 500 may be administered by a card issuer or payment scheme, thus be involved in the provision of financial services over a network and thereby collect data relating to merchants, account holders or customers, developers, issuers, acquirers, purchases made, and services provided by system 500 and systems and third parties with which the system 500 interacts. For example, server system 502 could be in communication with an interchange network.

Similarly, database 508 may also store account data including at least one of a cardholder name, a cardholder address, an account number, and other account identifier. Database 508 may also store merchant data including a merchant identifier that identifies each merchant registered on the network, and instructions for settling transactions and recording information for analysis using methods according to FIGS. 1 and 2.

The database 508 may also be a non-transitory computer readable medium storing or embodying a computer program for optimizing an item descriptor and item value combination, and/or for determining an effect of a deviation in an item descriptor and item value combination. The program may include at least one code segment executable by a computer to instruct the computer to perform a method as described herein, for example with reference to FIG. 1 or 2.

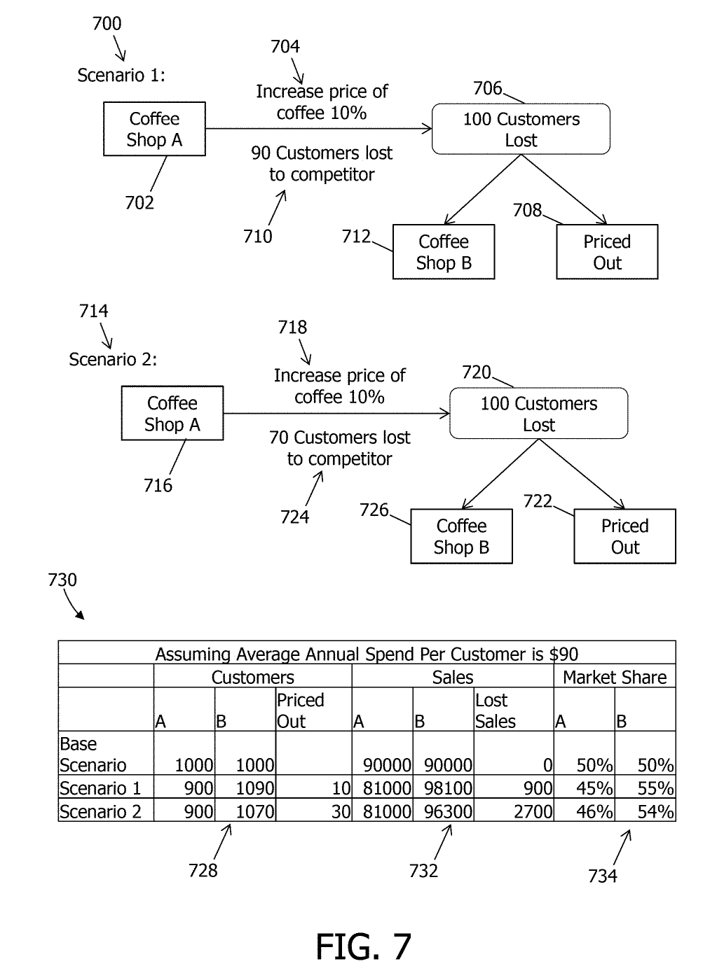

With reference to FIG. 7, scenarios are shown in which the nature of the consumer response to those changes may have been forecast using the methods of FIGS. 1 and 2. Both scenarios suggest the same type of change, but illustrate how secondary considerations based on previous transaction data elements can assist in distinguishing one consumer response from another, and thus more accurately discerning which type of change to make depending on the desired outcome (e.g. higher profit and/or higher market share).

Assuming a starting customer base of 1,000 customer, in Scenario 1 (700) Coffee Shop A (702) increases prices by 10% from an original or current price (704). As a result, 100 customers are lost (706). This response might have been understood by some analysis methods. However, the methods of FIGS. 1 and 2 can forecast an expected migration of customers, or purchases, out of the market (10 customers priced out—708). The present methods may also forecast an expected migration of clients to a competitor (710) and even specify the competitor to which they may migrate (Coffee Shop B—712).

Again assuming a customer base of 1,000 customers, in Scenario 2 (714) Coffee Shop A (716) makes the same price increase of 10% (718). Again 100 customers are lost from Coffee Shop A (720). However, in this scenario, 30% of the lost customers are priced out of the market (722). Thus, 70% of the lost customers move over to a competitor (724), namely Coffee Shop B (726).

We can now analyze these forecasts assuming a constant consumer spend, to illustrate the different scenarios that may be encountered, that would not be evident when using methods that can only forecast the number of customers that may be lost by any particular change. Part 728 of the table (730) shows the numbers of customers for each of Coffee Shops A and B in line with each of Scenarios 1 and 2 above. Part 732 of table 730 shows the forecast revenue for each of Coffee Shops A and B based on the original customer base of 1,000 customers per coffee shop, and then the forecast revenue derived after the changes are made per the above Scenarios 1 and 2. Lastly, part 734 shows that while Scenarios 1 and 2 provide the same impact on revenue, Scenario 2 yields a higher market share than Scenario 1. Thus, if Coffee Shop A is the merchant in question, and is given a number of options for making desired changes to the initial data, Scenario 2 might provide one of the options that would yield a benefit and would have been masked when considering pure customer base data gain/loss data when compared with other factors, such as market share.

Similarly, other scenarios can yield an increased industry customer base, and thus higher profit for the merchant in question even where market share declines. It is these secondary impacts of changes to initial data in which the present methods can be particularly useful.

FIG. 6 illustrates an exemplary configuration of a computing device 600, similar to server system 500 (shown in FIG. 5). Computing device 600 may include, but is not limited to, database server, application server, web server, fax server, directory server, and mail server.

Server computing device 600 also includes a processor 602 for executing instructions. Instructions may be stored, for example, in a memory area 604 or other computer-readable media. Processor 602 may include one or more processing units (e.g., in a multi-core configuration)

Processor 602 may be operatively coupled to a communication interface 606 such that server computing device 600 is capable of communicating with a remote device, such as user computing device 604 (shown in FIG. 6) or another server computing device 600. For example, communication interface 606 may receive requests from client system 604 via the Internet.

Processor 602 may also be operatively coupled to storage device 608. Storage device 608 is any computer-operated hardware suitable for storing and/or retrieving data. In some embodiments, storage device 608 is integrated in server computing device 600. For example, server computing device 608 may include one or more hard disk drives as storage device 608. In other embodiments, storage device 608 is external to server computing device 600 and may be accessed by a plurality of server computing devices 600. For example, storage device 608 may include multiple storage units such as hard disks or solid state disks in a redundant array of inexpensive disks (RAID) configuration. Storage device 608 may include a storage area network (SAN) and/or a network attached storage (NAS) system.

In some embodiments, processor 600 is operatively coupled to storage device 608 via a storage interface 610. Storage interface 610 is any component capable of providing processor 602 with access to storage device 608. Storage interface 610 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 602 with access to storage device 608.

In operation, the processor 602, coupled to a memory device (including memory device 604 and storage device 608), is configured to receive initial data that includes an initial item descriptor, an initial merchant identifier, and an initial item value. The processor is configured to thereafter locate, from a database that includes one or more previous transaction data points, each includes:

an archival item descriptor, the archival item descriptor being comparable to the initial item descriptor;

an archival merchant identifier;

an archival item value; and

a transaction date.

Before or after locating previous transaction data points, the processor is configured to create a plurality of candidate opportunity variants each includes a candidate item descriptor that is comparable to the initial item descriptor, and a candidate item value. Once the candidate opportunity variants are created, the processor then, for each candidate opportunity variant, determines a first deviation, being a deviation of the respective candidate item descriptor and candidate item value from the respective initial item descriptor and initial item value and identifies, in the one or more previous transaction data points, a first set of first previous transaction data points and a second set of previous transaction data points. The sets of data points are selected to be such that the transaction dates of the previous transaction data points of the first set are earlier than the transaction dates of the previous transaction data points of the second set, and a second deviation, being a deviation between the archival item descriptors and archival item values of the previous transaction data points of the second set and the archival item descriptors and candidate item values of the previous transaction data points of the first set, is associable to the first deviation. Once these steps are completed for each candidate opportunity variant, the processor is configured to forecast a number of new transaction data points at at least one future date, each new transaction data point includes a forecast merchant identifier, and where the forecast merchant identifier is the initial merchant identifier, the respective new transaction data point includes the respective candidate item descriptor and candidate item value, and a forecast merchant identifier, and select a candidate opportunity variant. The candidate opportunity variant may be selected on any basis, including it being the candidate opportunity variant providing a higher number of new transaction data points, for which the forecast merchant identifier is the initial merchant identifier, than the other candidate opportunity variants, and/or a higher total value than a total value for the other candidate opportunity variants, wherein the total value for each candidate opportunity variant is the respective number of new transaction data points multiplied by the respective candidate item value.

The processor may be similarly configured to receive an initial item descriptor and item value combination, and a proposed item descriptor and item value combination, determine a first deviation, being a deviation of the proposed item descriptor and proposed item value from the respective initial item descriptor and initial item value, and then perform the same locating step, identifying step and forecasting step as set out above, for the single first deviation rather than for a plurality of first deviations (one for each candidate opportunity variant).

The computer system 600 may be instructed by a computer program embodied on a non-transitory computer readable medium, such as memory device 604 or storage device 608. The program stored on the device 604 or 608 would include at least one code segment, and most likely many thousands of code segments, executable by a computer to instruct the computer to perform the requested operations.

Similarly, the program may be stored remotely. To this end, the computer system may constitute a client computer system of a network-based system for performing the above methods.

Many modifications and variations of the present teachings will be apparent to the skilled person in light of the present disclosure. All such modifications and variations are intended to fall within the scope of the present disclosure. Moreover, to the extent possible, features form one of the embodiments described herein may be used in one or more other embodiments to enhance or replace a feature of the one or more other embodiments. All such usage, substitution, and replacement are intended to fall within the scope of the present disclosure.

1. A method for optimizing an item descriptor and item value combination, comprising:
receiving initial data comprising an initial item descriptor, an initial merchant identifier, and an initial item value;
locating, from a database comprising previous transaction data points, one or more previous transaction data points each comprising:
an archival item descriptor, the archival item descriptor being comparable to the initial item descriptor;
an archival merchant identifier;
an archival item value; and
a transaction date;
creating a plurality of candidate opportunity variants each comprising a candidate item descriptor that is comparable to the initial item descriptor, and a candidate item value and, for each candidate opportunity variant:
determining a first deviation, being a deviation of the candidate item descriptor and candidate item value from the initial item descriptor and initial item value;
identifying, in the one or more previous transaction data points, a first set of first previous transaction data points and a second set of previous transaction data points, wherein:
the transaction dates of the first set of first previous transaction data points are earlier than the transaction dates of the second set of previous transaction data points; and
a second deviation, being a deviation between the archival item descriptors and archival item values of the second set of previous transaction data points, and the archival item descriptors and candidate item values of the first set of first previous transaction data points, is associable to the first deviation; and
forecasting one or more new transaction data points at at least one future date, each new transaction data point comprising a forecast merchant identifier, wherein the forecast merchant identifier is the initial merchant identifier, and wherein the new transaction data point comprises the candidate item descriptor and candidate item value, and the forecast merchant identifier; and
selecting the candidate opportunity variant that provides an optimized item descriptor and item value combination based on the selected candidate opportunity variant having at least one of:
a higher number of new transaction data points, for which the forecast merchant identifier is the initial merchant identifier, compared to a number of new transaction data points for other candidate opportunity variants; and
a higher total value than a total value for the other candidate opportunity variants, wherein the total value for each candidate opportunity variant is the number of new transaction data points multiplied by the candidate item value.

2. A method according to claim 1, wherein, for each new transaction data point, the forecast merchant identifier comprises one of the initial merchant identifier and a competitor merchant identifier.

3. A method according to claim 1, wherein each item value comprises a sale price for sale of an item conforming to the item descriptor, minus a cost price for delivery of the item.

4. A method according to claim 1, wherein each previous transaction data point comprises an archival transactor identifier and each new transaction data point comprises a transactor identifier, each transactor identifier being either a said archival transactor identifier or a new transactor identifier, and wherein forecasting one or more new transaction data points at at least one future date comprises forecasting a change in the one or more new transaction data points for each archival transactor identifier, for which the forecast merchant identifier comprises the initial merchant identifier.

5. A method according to claim 1, wherein each previous transaction data point comprises an archival transactor identifier and each new transaction data point comprises a transactor identifier, each transactor identifier being either a said archival transactor identifier or a new transactor identifier, and wherein forecasting one or more new transaction data points at at least one future date comprises forecasting a change in the one or more new transaction data points for each archival transactor identifier.

6. A method of claim 5, further comprising determining a change in the one or more new transaction data points for which the merchant identifier is the initial merchant identifier relative to the one or more new transaction data points for which the merchant identifier is a particular merchant identifier other than the initial merchant identifier.

7. A method according to claim 6, wherein the selected candidate opportunity variant is the candidate opportunity variant with a higher number of new transaction data points, for which the forecast merchant identifier is the initial merchant identifier, compared to a number of new transaction data points for the other candidate opportunity variants, relative to a number of new transaction data points for which the merchant identifier is the particular merchant identifier.

8. A method according to claim 4, wherein each transactor identifier represents an individual and forecasting one or more new transaction data points at at least one future date comprises determining at least one of the changes in the number of new transactions for the individual.

9. A method according to claim 4, wherein each transactor identifier represents a customer segment and forecasting one or more new transaction data points at at least one future date comprises determining at least one of the changes in the one or more new transactions for the customer segment.

10. A method according to claim 1, wherein forecasting one or more new transaction data points at at least one future date comprises forecasting a number of new transaction data points at a plurality of future dates, and selecting the candidate opportunity variant comprises to ascertain at least one of:
a change in the one or more new transaction data points over time; and
a change in the one or more new transaction data points for each merchant identifier over time.

11. A method according to claim 4, wherein forecasting one or more new transaction data points at at least one future date comprises forecasting a number of new transaction data points at a plurality of future dates to ascertain at least one of:
a change, over time, in the one or more new transaction data points for each archival transactor identifier, for which the forecast merchant identifier comprises the initial merchant identifier;
a change, over time, in the one or more new transaction data points for each archival transactor identifier, for which the forecast merchant identifier is a particular merchant identifier that is different from the initial merchant identifier; and
a change, over time, in the one or more new transaction data points for each archival transactor identifier.

12. A method for determining an effect of a deviation in an item descriptor and item value combination, comprising:
receiving an initial item descriptor and item value combination, and a proposed item descriptor and item value combination;
determining a first deviation, being a deviation of the proposed item descriptor and proposed item value from the respective initial item descriptor and initial item value;
locating, from a database comprising previous transaction data points, one or more previous transaction data points each comprising:
an archival item descriptor, the archival item descriptor being comparable to the initial item descriptor;
an archival merchant identifier;
an archival item value; and
a transaction date;
identifying, in the one or more previous transaction data points, a first set of first previous transaction data points and a second set of previous transaction data points, wherein:
the transaction dates of the first set of first previous transaction data points are earlier than the transaction dates of the second set of previous transaction data points; and
a second deviation, being a deviation between the archival item descriptors and archival item values of the second set of previous transaction data points, and the archival item descriptors and candidate item values of the first set of first previous transaction data points, is associable to the first deviation; and
forecasting one or more new transaction data points at at least one future date, each new transaction data point comprising a forecast merchant identifier.

13. A method according to claim 12, wherein, for each new transaction data point, the forecast merchant identifier comprises one of the initial merchant identifier and a competitor merchant identifier.

14. A method according to claim 12, wherein each item value comprises a sale price for sale of an item conforming to the item descriptor, minus a cost price for delivery of the item.

15. A method according to claim 12 wherein each previous transaction data point comprises an archival transactor identifier and each new transaction data point comprises a transactor identifier, each transactor identifier being either a said archival transactor identifier or a new transactor identifier, and wherein the forecasting step comprises forecasting a change in the one or more new transaction data points for each archival transactor identifier, for which the forecast merchant identifier comprises the initial merchant identifier.

16. A method according to claim 12, wherein each previous transaction data point comprises an archival transactor identifier and each new transaction data point comprises a transactor identifier, each transactor identifier being either a said archival transactor identifier or a new transactor identifier, and wherein forecasting one or more new transaction data points at at least one future date comprises forecasting a change in the number of new transaction data points for each archival transactor identifier.

17. A method of claim 12, further comprising determining a change in the one or more new transaction data points for which the merchant identifier is the initial merchant identifier relative to the one or more new transaction data points for which the merchant identifier is a particular merchant identifier other than the initial merchant identifier.

18. A method according to claim 15, wherein each transactor identifier represents an individual and forecasting one or more new transaction data points at at least one future date comprises determining at least one of the changes in the one or more new transactions for the individual.

19. A method according to claim 15, wherein each transactor identifier represents a customer segment and forecasting one or more new transaction data points at at least one future date comprises determining at least one of the changes in the one or more new transactions for the customer segment.

20. A method for determining an effect of a deviation in an item descriptor and item value combination, comprising:
receiving an initial item descriptor and item value combination, and a proposed item descriptor and item value combination;
determining a first deviation, being a deviation of the proposed item descriptor and proposed item value from the initial item descriptor and initial item value;
locating, from a database comprising previous transaction data points, one or more previous transaction data points each comprising:
an archival item descriptor, the archival item descriptor being comparable to at least one of the initial item descriptor and the proposed item descriptor;
an archival merchant identifier;
an archival item value; and
a transaction date;
identifying, in the one or more previous transaction data points, a first set of first previous transaction data points and a second set of previous transaction data points, wherein:
the transaction dates of the first set of first previous transaction data points are earlier than the transaction dates of the second set of previous transaction data points; and
a second deviation, being a deviation between the archival item descriptors and archival item values of the second set of previous transaction data points, and the archival item descriptors and candidate item values of the first set of first previous transaction data points, is associable to the first deviation; and
forecasting of one or more new transaction data points at at least one future date, each new transaction data point comprising a forecast merchant identifier.

21. A method according to claim 20, wherein the archival item descriptor for each previous transaction data point in the first set of previous transaction data points is comparable to the initial item descriptor.

22. A method according to claim 20, wherein the archival item descriptor for each previous transaction data point in the second set of previous transaction data points is comparable to the proposed item descriptor.

23. A computer system for optimizing an item descriptor and item value combination, the computer system comprising:
a memory device for storing data;
a display; and
a processor coupled to the memory device and being configured to:
receive initial data comprising an initial item descriptor, an initial merchant identifier, and an initial item value;
locate, from a database comprising previous transaction data points, one or more previous transaction data points each comprising:
an archival item descriptor, the archival item descriptor being comparable to the initial item descriptor;
an archival merchant identifier;
an archival item value; and
a transaction date;
create a plurality of candidate opportunity variants each comprising a candidate item descriptor that is comparable to the initial item descriptor, and a candidate item value and, for each candidate opportunity variant:
determine a first deviation, being a deviation of the candidate item descriptor and candidate item value from the initial item descriptor and initial item value;
identify, in the one or more previous transaction data points, a first set of first previous transaction data points and a second set of previous transaction data points, wherein:
the transaction dates of the first set of first previous transaction data points are earlier than the transaction dates of the second set of previous transaction data points; and
a second deviation, being a deviation between the archival item descriptors and archival item values of the second set of previous transaction points, and the archival item descriptors and candidate item values of the first set of first previous transaction data points, is associable to the first deviation;
forecast one or more new transaction data points at at least one future date, each new transaction data point comprising a forecast merchant identifier, and where the forecast merchant identifier is the initial merchant identifier, the new transaction data point comprises the candidate item descriptor and candidate item value, and a forecast merchant identifier; and
select the candidate opportunity variant that provides an optimized item descriptor and item value combination based on the selected candidate opportunity variant having at least one of:
a higher number of new transaction data points, for which the forecast merchant identifier is the initial merchant identifier, compared to a number of new transaction data points for other candidate opportunity variants; and
a higher total value than a total value for the other candidate opportunity variants, wherein the total value for each candidate opportunity variant is the number of new transaction data points multiplied by the candidate item value.

24. A computer system for determining an effect of a deviation in an item descriptor and item value combination, the computer system comprising:
a memory device for storing data;
a display; and
a processor coupled to the memory device and being configured to:
receive an initial item descriptor and item value combination, and
a proposed item descriptor and item value combination;
determine a first deviation, being a deviation of the proposed item descriptor and proposed item value from the initial item descriptor and initial item value;
locate, from a database comprising previous transaction data points, one or more previous transaction data points each comprising:
an archival item descriptor, the archival item descriptor being comparable to the initial item descriptor;
an archival merchant identifier;
an archival item value; and
a transaction date;
identify, in the one or more previous transaction data points, a first set of first previous transaction data points and a second set of previous transaction data points, wherein:
the transaction dates of the first set of first previous transaction data points are earlier than the transaction dates of the second set of previous transaction data points; and
a second deviation, being a deviation between the archival item descriptors and archival item values of the second set of previous transaction data points, and the archival item descriptors and candidate item values of first set of first previous transaction data points, is associable to the first deviation; and
forecast one or more new transaction data points at at least one future date, each new transaction data point comprising a forecast merchant identifier.

25. A computer program embodied on a non-transitory computer readable for optimizing an item descriptor and item value combination, the program comprising at least one code segment executable by a computer to instruct the computer to:
receive initial data comprising an initial item descriptor, an initial merchant identifier, and an initial item value;
locate, from a database comprising previous transaction data points, one or more previous transaction data points each comprising:
an archival item descriptor, the archival item descriptor being comparable to the initial item descriptor;
an archival merchant identifier;
an archival item value; and
a transaction date;
create a plurality of candidate opportunity variants each comprising a candidate item descriptor that is comparable to the initial item descriptor, and a candidate item value and, for each candidate opportunity variant:
determine a first deviation, being a deviation of the candidate item descriptor and candidate item value from the initial item descriptor and initial item value;
identify, in the one or more previous transaction data points, a first set of first previous transaction data points and a second set of previous transaction data points, wherein:
the transaction dates of the first set of first previous transaction data points are earlier than the transaction dates of the second set of previous transaction data points; and
a second deviation, being a deviation between the archival item descriptors and archival item values of the second set of previous transaction data points, and the archival item descriptors and candidate item values of the first set of first previous transaction data points, is associable to the first deviation; and
forecast one or more new transaction data points at at least one future date, each new transaction data point comprising a forecast merchant identifier, and where the forecast merchant identifier is the initial merchant identifier, the new transaction data point comprises the candidate item descriptor and candidate item value, and a forecast merchant identifier; and
select the candidate opportunity variant that provides an optimized item descriptor and item value combination based on the selected candidate opportunity variant having at least one of:
a higher number of new transaction data points, for which the forecast merchant identifier is the initial merchant identifier, compared to a number of new transaction data points for other candidate opportunity variants; and
a higher total value than a total value for the other candidate opportunity variants, wherein the total value for each candidate opportunity variant is the number of new transaction data points multiplied by the candidate item value.

26. A computer program embodied on a non-transitory computer readable for determining an effect of a deviation in an item descriptor and item value combination, the program comprising at least one code segment executable by a computer to instruct the computer to:
receive an initial item descriptor and item value combination, and a proposed item descriptor and item value combination;
determine a first deviation, being a deviation of the proposed item descriptor and proposed item value from the respective initial item descriptor and initial item value;
locate, from a database comprising previous transaction data points, one or more previous transaction data points each comprising:
an archival item descriptor, the archival item descriptor being comparable to the initial item descriptor;
an archival merchant identifier;
an archival item value; and
a transaction date;
identify, in the one or more previous transaction data points, a first set of first previous transaction data points and a second set of previous transaction data points, wherein:
the transaction dates of the first set of first previous transaction data points are earlier than the transaction dates of the second set of previous transaction data points; and
a second deviation, being a deviation between the archival item descriptors and archival item values of the second set of previous transaction data points and the archival item descriptors and candidate item values of the first set of first previous transaction data points, is associable to the first deviation; and
forecast one or more new transaction data points at at least one future date, each new transaction data point comprising a forecast merchant identifier.

27. A network-based system for optimizing an item descriptor and item value combination, the system comprising:
a client computer system;
at least one database;
a display; and
a server system coupled to the client computer system and the database, the server system configured to:
receive, from the client computer system, the initial data comprising an initial item descriptor, an initial merchant identifier and an initial item value;
locate, from a database comprising previous transaction data points, one or more previous transaction data points each comprising:
an archival item descriptor, the archival item descriptor being comparable to the initial item descriptor;
an archival merchant identifier;
an archival item value; and
a transaction date;
create a plurality of candidate opportunity variants each comprising a candidate item descriptor that is comparable to the initial item descriptor, and a candidate item value and, for each candidate opportunity variant:
determine a first deviation, being a deviation of the respective candidate item descriptor and candidate item value from the respective initial item descriptor and initial item value;
identify, in the one or more previous transaction data points, a first set of first previous transaction data points and a second set of previous transaction data points, wherein:
the transaction dates of the first set of first previous transaction data points are earlier than the transaction dates of the second set of previous transaction data points; and
a second deviation, being a deviation between the archival item descriptors and archival item values of the second set of previous transaction data points and the archival item descriptors and candidate item values of the first set of first previous transaction data points, is associable to the first deviation; and
forecast one or more new transaction data points at at least one future date, each new transaction data point comprising a forecast merchant identifier, and where the forecast merchant identifier is the initial merchant identifier, the new transaction data point comprises the candidate item descriptor and candidate item value, and a forecast merchant identifier; and
select the candidate opportunity variant that provides an optimized item descriptor and item value combination based on the selected candidate opportunity variant having at least one of:
a higher number of new transaction data points, for which the forecast merchant identifier is the initial merchant identifier, compared to a number of new transaction data points for other candidate opportunity variants; and
a higher total value than a total value for the other candidate opportunity variants, wherein the total value for each candidate opportunity variant is the number of new transaction data points multiplied by the candidate item value.

28. A network-based system for determining an effect of a deviation in an item descriptor and item value combination, the system comprising:
a client computer system;
at least one database;
a display; and
a server system coupled to the client computer system and the database, the server system configured to:
receive, from the client computer system, an initial item descriptor and item value combination, and a proposed item descriptor and item value combination;
determine a first deviation, being a deviation of the proposed item descriptor and proposed item value from the initial item descriptor and initial item value;
locate, from a database comprising previous transaction data points, one or more previous transaction data points each comprising:
an archival item descriptor, the archival item descriptor being comparable to the initial item descriptor;
an archival merchant identifier;
an archival item value; and
a transaction date;
identify, in the one or more previous transaction data points, a first set of first previous transaction data points and a second set of previous transaction data points, wherein:
the transaction dates of the first set of first previous transaction data points are earlier than the transaction dates of the second set of previous transaction data points; and
a second deviation, being a deviation between the archival item descriptors and archival item values of the second set of previous transaction data points and the archival item descriptors and candidate item values of the first set of first previous transaction data points, is associable to the first deviation; and
forecast one or more new transaction data points at at least one future date, each new transaction data point comprising a forecast merchant identifier.
